(19) United States
(12) Patent Application Publication
(10) Pub. No.: US 2021/0282906 A1
(43) Pub. Date: Sep. 16, 2021

(54) COMBINATION CUSTOM TRAY AND BITE BLOCK

(71) Applicant: Robert Popp, Greendale, WI (US)

(72) Inventor: Robert Popp, Greendale, WI (US)

(21) Appl. No.: 17/200,216

(22) Filed: Mar. 12, 2021

Related U.S. Application Data
(60) Provisional application No. 62/989,353, filed on Mar. 13, 2020.

(51) Int. Cl. A61C 9/00

(52) U.S. Cl. CPC A61C 9/0006; A61C 13/0003

(57) ABSTRACT

A custom denture tray for fabricating a set of dentures that includes an upper tray that includes a baseplate. The baseplate has a top side configured to hold material for capturing a dental impression. A bite block is attached to a bottom side of the baseplate. The bite block is made of a relatively soft material which can be marked to show positions for artificial teeth to be placed in the dentures. In particular embodiments, the denture tray includes a removable handle configured to be attached to a front portion of the mouthpiece. The removable handle may be attached so that it protrudes from a user's mouth when the mouthpiece is in the user's mouth.

### CROSS-REFERENCE TO RELATED PATENT APPLICATIONS

This patent application claims the benefit of U.S. Provisional Patent Application No. 62/989,353, filed Mar. 13, 2020, the entire teachings and disclosure of which are incorporated herein by reference thereto.

### FIELD OF THE INVENTION

This invention generally relates to a combination custom impression denture tray and baseplate/bite block.

### BACKGROUND OF THE INVENTION

Currently, dental patients typically need from 4 to 5 appointments with the dentist in order to fabricate a set of dentures. During the first appointment, primary impressions are taken with a stock impression tray. This is done by placing alginate impression material into the mouthpiece of the impression tray and placing the mouthpiece into the patient's mouth to capture the tissue surfaces of the patients upper or lower jaws. A plaster material is then poured into the impression to create a model for the fabrication of a custom tray. The custom tray is fabricated slightly larger (about 2 to 3 millimeters) than the model to accommodate space for the impression material. This allows for a uniform thickness of impression material unlike the stock tray.

During the second appointment, a custom tray is fabricated to take the secondary impression by filling the mouthpiece of the custom tray with alginate impression material or a light body polyvinylsiloxene material which captures the tissue more accurately than the original stock tray. In some cases, a border mold of the periphery of the custom tray is made to capture a more accurate impression of the tissue where the extensions of the final dentures will fit in the patient's mouth. A stone material is poured into the custom tray impression for fabrication of the baseplate/bite block.

In the third appointment, during which a determination jaw relations is made, and in which bite block markings and adjustments are made, the baseplate/bite block is fabricated by adapting a vacuum formed plastic sheet, light cured resin or a two part mixed resin to adapt to the custom tray model. After the baseplate is trimmed to fit the model, a wax bite block is adhered to the baseplate. The baseplate/bite block is used by the dentist to mark on the wax bite block the patient's midline (the line between the patient's front teeth).

All of these markings described above are used by the laboratory to set the artificial teeth for the final denture. The marking are necessary for the proper placement of the teeth to allow the patient a natural looking smile and for attaining normal speech without lisping.

However, it would be advantageous if dentures could be made without multiple visits to the dentist. This would speed up the denture-making process and reduce cost for the patient. Embodiments of the present invention provide an improved process for making dentures. These and other advantages of the invention, as well as additional inventive features, will be apparent from the description of the invention provided herein.

### BRIEF SUMMARY OF THE INVENTION

In one aspect, embodiments of the invention provide a custom denture tray for fabricating a set of dentures that includes an upper tray that includes a baseplate. The baseplate has a top side configured to hold material for capturing a dental impression. A bite block is attached to a bottom side of the baseplate. The bite block is made of a relatively soft material which can be marked to show positions for artificial teeth to be placed in the dentures. Embodiments of the invention may further include a lower tray with a bottom side configured to hold material for capturing a dental impression, along with a lower tray bite block attached to a top side of the lower tray. In certain embodiments, the lower tray is U-shaped with a channel for holding the material that captures the dental impression.

In a further embodiment, the custom denture tray also includes a removable handle is configured to be attached to a front portion of the mouthpiece. The removable handle is attached such that it protrudes from a user's mouth when the upper tray is in the user's mouth. In more particular embodiments of the invention, the removable handle is used in both the upper and lower custom trays. In the lower tray, the removable handle is not attached to a baseplate, as the lower tray does not include a baseplate. In this case, the removable handle may be attached to a perimeter edge of the lower tray.

In certain embodiments, the bottom side of the baseplate for the upper tray includes retention nubs to strengthen the attachment between the baseplate and bite block. Similarly, the top side of the lower tray may include lower tray retention nubs to strengthen the attachment between the baseplate and lower tray bite block. The retention nubs may extend from the upper tray in a direction that is normal to the surface of the upper tray where the retention nubs are attached. Similarly, the lower tray retention nubs may extend from the lower tray in a direction that is normal to the surface of the lower tray where the lower tray retention nubs are attached. However, the retention nubs and lower tray retention nubs may extend from their respective upper and lower trays at an angle other than normal.

In a particular embodiment of the invention, the baseplate has a crenellated perimeter edge. It is also possible that the lower tray could include crenellations along a perimeter thereof. In other embodiments, the perimeter edge has a thicker cross-section than an interior portion of the baseplate. In certain embodiments, the bite block (or lower tray bite block) is made from wax or from a thermally-activated plastic material. Further, in some embodiments, the bottom side of the baseplate includes an attachment mechanism for the removable handle.

A particular embodiment of the invention incorporates five or more sizes of upper and lower trays with removable handles to accommodate different sizes of jaw ridges and arches for different dental patients. Included, as part of the impression trays, is an attached bite block for the additional information the dentist would need to convey to the lab for the fabrication of a denture.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of a custom tray and bite block, constructed in accordance with an embodiment of the invention;

FIG. 2 is an exploded view of the custom tray and bite block of FIG. 1;

FIG. 3 is a bottom view of the custom tray, according to an embodiment of the invention;

FIG. 4 is a cross-sectional view of the custom tray and bite block of FIG. 1; and

FIG. 5 shows upper and lower views of a lower custom tray, constructed in accordance with an embodiment of the invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

An embodiment of the present invention incorporates a mouthpiece with multiple sizes of upper and lower denture trays, some with removable handles, to accommodate different sizes of jaw ridges and arches for different dental patients. In certain embodiments of the invention, there is included, as part of the custom impression trays, an attached bite block for the additional information the dentist would need to convey to the lab for the fabrication of a denture. More specifically, embodiments of the present invention generally relate to a combination impression tray and baseplate/bite block that allows the dentist to eliminate at least one appointment at the beginning of the fabrication of a denture.

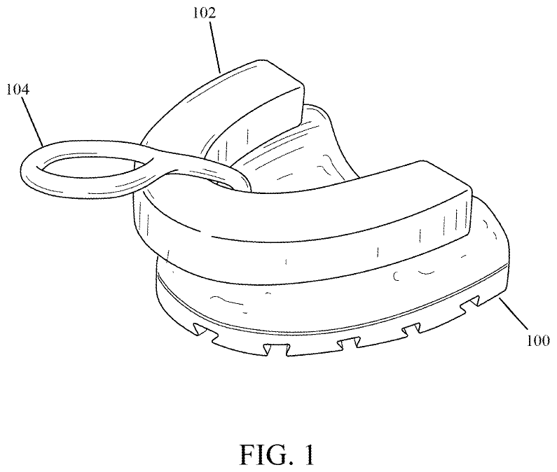

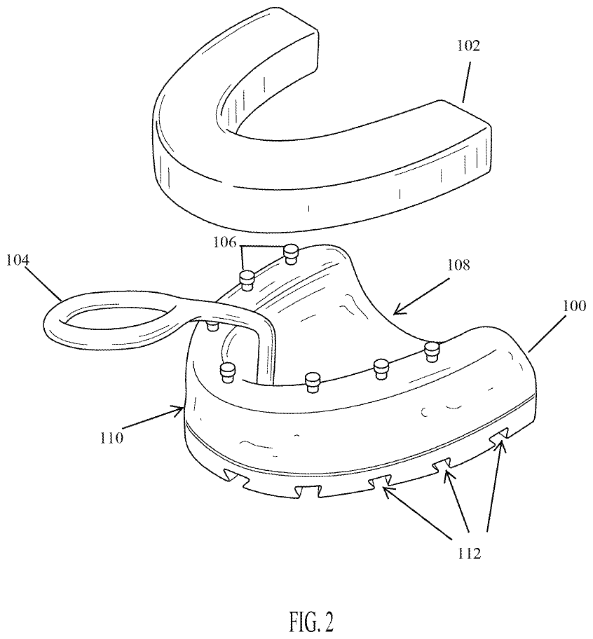

In an embodiment of the invention, a custom denture tray and bite block is provided in a range of different sizes. For example, there may be small, medium, and large upper and lower custom denture trays and corresponding bite blocks, along with one or more extra-large and/or extra-small sizes. FIG. 1 shows a perspective view of an upper tray 100 and bite block 102 joined together, in accordance with an embodiment of the invention, while FIG. 2 shows an exploded perspective view of the same upper tray 100 and bite block 102. In the embodiment shown, the upper tray 100 includes a handle 104 and a plurality of retention nubs 106 to aid and strengthen the attachment between the upper tray 100 and the bite block 102. The handle 104 is removable in particular embodiments.

In more particular embodiments of the invention, the removable handle 104 is used in both the upper custom tray 100 and lower custom tray 150. In the lower tray 150, the removable handle 104 is not attached to a baseplate 108, as the lower tray 150 does not include a baseplate 108. In this case, the removable handle 104 may be attached to a perimeter edge of the lower tray 150.

In alternate embodiments of the invention, the upper tray 100 does not include the handle 104 and may not include the retention nubs 106. In other embodiments, the upper tray 100 may have fewer or greater than the seven retention nubs 106 shown in FIG. 2. In the embodiments shown, the retention nubs 106 extend from the upper tray 100 in a direction that is normal to the surface of the upper tray 100 where the retention nubs 106 are attached. However, it is envisioned that, in other embodiments, the retention nubs 106 may extend from the upper tray 100 at an angle that other than is normal.

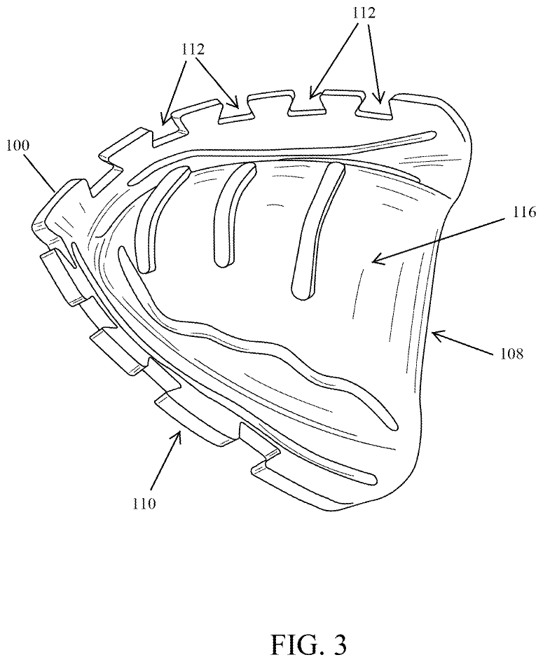

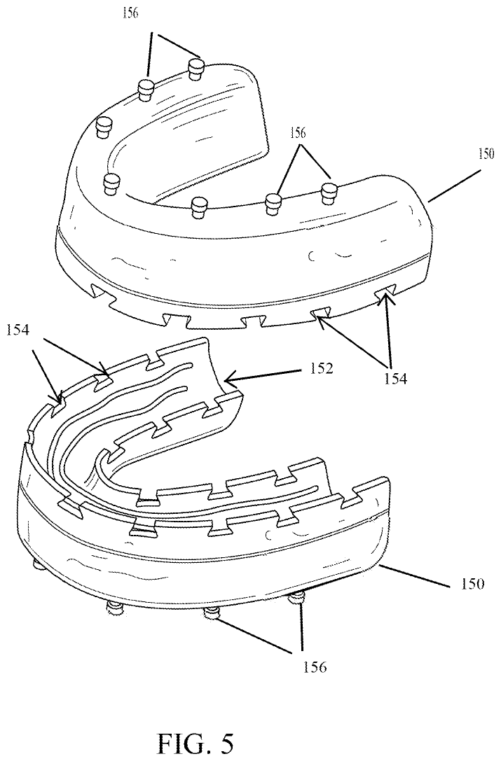

FIG. 3 is a bottom view of the custom upper tray 100, according to an embodiment of the invention. In the embodiments shown, the upper tray 100 includes a baseplate 108 shaped to match, or conform to, the shape of the patient's palate. In certain embodiments, the baseplate 108 has a perimeter edge 110. When the upper tray 100 is in the patient's mouth, the perimeter edge 110 is typically outside of the patient's top row of teeth or upper gum line. In particular embodiments, the perimeter edge 110 is crenellated so that, when the impression is taken, any overflow of the impression-making material can gather in the gaps of the crenellations 112. These crenellations 112 are also referred to as retention grooves. Though not shown in the drawings, the lower tray 150 of FIG. 5 could also include crenellations along a perimeter portion.

During use, the top side 116 of the upper tray 100 is filled with an impression-making material, such as an alginate, to obtain an accurate model of the patient's mouth. The removable handle 104 may be attached to an attachment mechanism located at a front portion of the upper tray 100. In some embodiments, the attachment mechanism is located on a bottom side of the baseplate 108. In some embodiments, the removable handle 104 is curved or bent at an angle, such as a right angle for example, so that the removable handle 104 avoids the bite block 102 as it protrudes from the patient's mouth.

Following the impression, markings can be made on the bite block 102 to facilitate the manufacture of the denture. The bite block 102 is typically made from a soft material, such as wax for example which can be easily marked. Typical bite block markings include, but are not necessarily limited to: 1) the lip line (a line where the lip touches the bite block when at rest); 2) cuspid placement (the lines where the cuspids should be placed); 3) the occlusal plane which, in some embodiments, may be created by melting the wax and removing it to obtain the correct occlusal plane in wax on the occlusal side of the bite block; and 4) the lip support which may be created by melting and removing the wax at the correct angle so that the artificial teeth will be placed to properly support the lip.

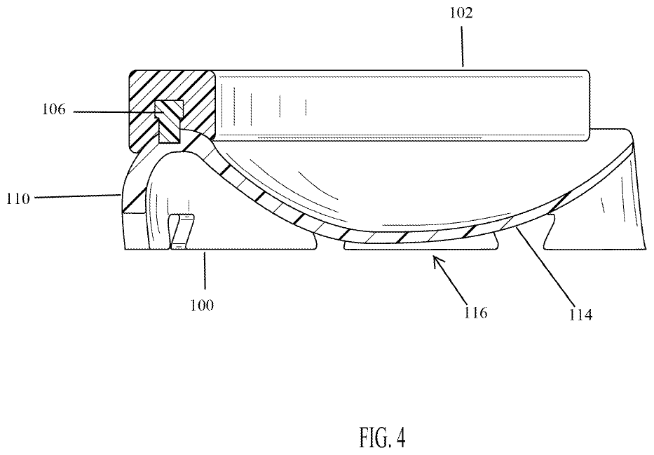

FIG. 4 is a cross-sectional view of the custom upper tray 100 and the bite block 102 of FIG. 1. In other embodiments, the perimeter edge 110 is thicker than an interior portion of the baseplate 108. Thus, the cross-section of the baseplate 108, as shown in the embodiment of FIG. 4, reveals a relatively uniform thickness of an interior portion 114 of the baseplate 108 and an increased thickness at the perimeter edge 110 of the baseplate 108. It can also be seen in this cross-sectional view how the retention nubs 106 is surrounded by the material of the bite block 102 thus enabling the retention nubs 106 to secure the bite block 102 to the upper tray 100.

As can be seen in FIG. 5, the bite block 102 for the upper custom tray 100 is similar to the bite block for the lower custom tray 150. Thus, while not shown in FIG. 5, in some embodiments, the bite block for the lower tray 150 is configured in the same way as the bite block 102 for the upper custom tray 100. Like the upper tray 100, embodiments of the lower tray 150 include a plurality of lower tray retention nubs 156 to aid and strengthen the attachment between the lower tray 150 and the lower tray bite block. In alternate embodiments of the invention, the lower tray 150 does not include the plurality of lower tray retention nubs 156, or may have varying numbers of the lower tray retention nubs 156. In other embodiment, the lower tray 150 may have fewer or greater than the seven lower tray retention nubs 156 shown in FIG. 5. But unlike the upper tray 100, the lower tray 150 does not include the baseplate 108, but instead resembles a U-shaped tray with a corresponding U-shaped channel 152 made to fit over the gum line and/or teeth of the dental patient's lower jaw. Certain embodiments of the lower tray 150 include crenellations 154 similar to those shown in the upper tray 100.

In a particular embodiment, the upper and lower bite blocks 102 may be made from a thermally-activated plastic material. In a more particular embodiment, the bite block material may be placed in hot water to soften the material so that it can be easily formed. The material softened in this manner is then placed on the dental tray and formed onto the dental tray in the desired shape. The impression-making process for the lower tray 150 is similar to that described above for the upper tray 100.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A custom denture tray for fabricating a set of dentures comprising:
an upper tray that includes a baseplate, wherein the baseplate has a top side configured to hold material for capturing a dental impression;
a bite block attached to a bottom side of the baseplate, the bite block being made of a relatively soft material which can be marked to show positions for artificial teeth to be placed in the dentures.

2. The denture tray of claim 1, further comprising a removable handle configured to be attached to a front portion of the upper tray, the removable handle attached such that it protrudes from a user's mouth when the upper tray is in the user's mouth.

3. The denture tray of claim 1, wherein the bottom side of the baseplate includes retention nubs to strengthen the attachment between the baseplate and the bite block.

4. The denture tray of claim 3, wherein the retention nubs extend from the upper tray in a direction that is normal to a surface of the upper tray where the retention nubs are attached.

5. The denture tray of claim 1, wherein the baseplate has a perimeter edge with one or more crenellations.

6. The denture tray of claim 5, wherein the perimeter edge has a thicker cross-section than an interior portion of the baseplate.

7. The denture tray of claim 1, wherein the bite block is made from wax.

8. The denture tray of claim 1, wherein the bite block is made from a thermally-activated plastic material.

9. The denture tray of claim 1, wherein the bottom side of the baseplate includes an attachment mechanism for the removable handle.

10. The denture tray of claim 1, wherein the baseplate is shaped to conform to the shape of a user's palate.

11. The denture tray of claim 1, further comprising a lower tray with a bottom side configured to hold material for capturing a dental impression.

12. The denture tray of claim 11, further comprising a lower tray bite block attached to a top side of the lower tray.

13. The denture tray of claim 11, wherein the top side of the lower tray includes lower tray retention nubs to strengthen the attachment between the lower tray and the lower tray bite block.

14. The denture tray of claim 13, wherein the lower tray retention nubs extend from the lower tray in a direction that is normal to a surface of the lower tray where the lower tray retention nubs are attached.

15. The denture tray of claim 11, wherein the lower tray is U-shaped with a channel for holding the material that captures the dental impression.
